(19) United States
(12) Patent Application Publication
(10) Pub. No.: US 2019/0005580 A1
(43) Pub. Date: Jan. 3, 2019

(54) MEDIUM OF EXCHANGE BASED ON RIGHT TO USE OR ACCESS INFORMATION

(71) Applicant: Brian Mark SHUSTER, Vancouver (CA)

(72) Inventor: Brian Mark SHUSTER, Vancouver (CA)

(21) Appl. No.: 16/124,030

(22) Filed: Sep. 6, 2018

Related U.S. Application Data
(63) Continuation of application No. 14/152,571, filed on Jan. 10, 2014, now abandoned.
(60) Provisional application No. 61/751,791, filed on Jan. 11, 2013.

(51) Int. Cl. G06Q 40/04; G06Q 20/06

(52) U.S. Cl. CPC G06Q 40/04; G06Q 20/065

(57) ABSTRACT

Methods, apparatus and systems for managing certificates used as a medium of economic exchange include issuing, by at least one computer, electronic certificates configured for use as digital currency units; publishing, by the at least one computer, a promise to redeem the electronic certificates for a right to access a digital object controlled by the at least one computer at a specified rate; and redeeming, by the at least one computer, ones of the electronic certificates for rights to access the digital object at the specified rates. The digital objects may include rights to use or access copyrighted digital content, and/or virtual objects or services useful only in a virtual online environment that is controlled via the one or more computers. The methods, apparatus and systems may include providing one of the electronic certificates to users, in exchange for value.

### CROSS-REFERENCE TO RELATED APPLICATION

This application is a continuation of U.S. patent application Ser. No. 14/152,571 filed Jan. 10, 2014, which claims priority pursuant to 35 U.S.C. § 119(e) to U.S. provisional application Ser. No. 61/751,791, filed Jan. 11, 2013, which are hereby incorporated by reference, in their entireties.

### FIELD

This application relates to methods and apparatus for managing certificates used as a medium of economic exchange.

### BACKGROUND

Modern economics has revealed that all current and prior systems and methods for creating and backing currencies have undesirable failings.

In the past, whenever a government has created a currency, it has fixed the currency to some other valuable asset. For example, under a precious metal (e.g., gold or silver) standard, a unit of currency is fixed to a specified quantity of precious metal. For further example, for a pegged currency, one unit of currency in country “A” id pegged a certain amount of currency of country “B” by action of a central bank in currency exchanges. The modern standard is for governments to “float” their currency, in which case the currency is backed by essentially nothing other than general public acceptance of it as a useful medium of exchange having a relatively stable value over at least short time periods.

With fixed currencies, governments have discovered the limitation that they cannot arbitrarily expand the amount of currency in circulation, because they must own at least an equal value of the asset that backs the currency as the sum total of the value of the currency that they circulate. While economists may disagree about the desirability and/or economic effects of using currency systems fixed to hard assets, political forces have led to almost universal abandonment of fixed currencies by issuing governments. In short, fixed currencies have been shown to have such significant problems that most countries have abandoned them as unviable currency systems.

The main alternative to fixed currencies, i.e., “floated” or “fiat” currencies, are subject to a different set of problems. Although floated currencies resolve the problem of fixed currencies inasmuch as the government can create or destroy the currency as it sees fit, the consequence of doing so has been shown directly to impact on inflation and deflation. If, for example, a country decides that it needs to double its money supply, it can create new currency equal to the amount of currency that currently exists. In doing so, however, the government has diluted the value of the currency by half, and thus, all currency is, essentially, worth only 50% of the value it held prior to the creation of the new currency, all other things being equal. This inflation effect has been observed throughout the history of fiat currency, most memorably in Zimbabwe in the 2000s and in Weimar Germany in the 1920s.

There have been numerous attempts to create a money system that reduces the problems inherent in both pegged and fiat currencies, such as limiting the ability of the currency in the amount that they could convert and allowing for the creation of local currencies to offset issues with a national currency. No solution, however, has heretofore been found that provides the guaranteed value of a fixed currency with the flexibility to money supply permitted by a fiat currency. A need exists to find a system and method to create a currency that holds an intrinsic value, but that also enables the issuer to create or destroy any amount of currency it deems appropriate to allow for ample liquidity and growth of the economy.

An example of digital currency that is neither tied to an underlying asset nor capable of infinite replication is BitCoin open source digital cash. Bitcoin is authenticated using a P2P system. Electronic certificates used for digital currency may also be authenticated with centralized systems; an example of such systems based on gold is e-gold. BitCoin derives its value as a medium of exchange by being, like gold, in relatively scarce supply (because of how the source code generates new BitCoins via “mining”), durable, divisible, and capable of being authenticated without knowing the identity of the holder. It can be exchanged for other currencies via a variety of private markets. Currently, it is unknown to what extent governments will tolerate Bitcoin and similar currencies, and what measures central banks may take to attempt to control it.

Within certain geographic or organized communities, community members may agree to accept I.O.U's, typically tied to a unit of labor, for example, an hour of time. One such system, for example, often referred to as “time banking” is promoted by organizations such as TimeBanks™ USA, which publishes a website located at www.timebanks.org. Such systems work well as a community-building tool, but are subject to certain disadvantages, such as being subject to exploitation by unethical community members, and requiring that every hour of labor be valued equally regardless of supply and demand for the labor in question. Similarly, other community currencies have been adopted by various groups, whose members agree to accept a group-issued certificate—essentially an I.U.O., in exchange for goods or services at a certain rate. These community-based systems may have various rules governing exchange and redemption of the group certificates, with some groups providing no official support for certificate redemption for cash (i.e., government-issued currency). In general, such systems suffer from the drawback of being useful only for limited purposes within a defined community.

The present disclosure provides methods, apparatus and systems for managing certificates used as a medium of economic exchange that overcomes certain disadvantages of these and other prior art methods and systems.

### SUMMARY

Methods, apparatus and systems for managing certificates used as a medium of economic exchange are disclosed, in which issuance of the certificate is tied to a right to use or access controlled (e.g., copyrighted or secret) information or to access on-line resources (e.g., an on-line game, database, or processor) in a specified amount. Managing certificates may include, for example, managing exchange value by publishing and executing a promise to redeem the certificates for a specified intangible product or service supplied via an on-line environment.

In an aspect, a method for managing certificates used as a medium of economic exchange may include issuing, by at least one computer, electronic certificates configured for use as digital currency units. For example, the at least one computer may issue a series of electronic certificates for use as digital currency by providing a unique electronic identifier for each certificate and a publicly available register of transactions recording most recent owners of the electronic certificates. In addition, the at least one computer may associate different public/private key pairs with respective ones of the electronic certificates enabling any person knowing the private key of the pair to control transfer of the electronic certificate to a new owner.

The method may further include publishing, by the at least one computer, a promise to redeem the electronic certificates for respective rights to access a digital object controlled by the at least one computer, at a specified rate. The specified rate may be a fixed rate, or a variable rate allowed to vary within a specified, relatively narrow range; for example plus or minus 10%. The at least one computer may be controlled by a single entity, sometimes referred to herein as an “issuer.” The digital object may be, or may include, information (e.g., entertainment content, business data, etc.) that is not generally or freely available to the public. Hence, the promise to redeem may act to support value of the electronic certificates as digital currency, based on a right to use or access information.

The method may further include redeeming, by the at least one computer, ones of the electronic certificates for rights to access the digital object at the specified rates. In an aspect, the digital objects may comprise copy-protected digital content. For example, the digital objects may be selected from electronic audio files or streamed audio content, audio/video files or streamed audio/video content, executable software, computer games, electronic data or computer graphic files. In the alternative, or in addition, the digital objects may comprise user access to a digital resource or service provided via a virtual online environment that is controlled via the one or more computers. A digital resource or service may include, for example, a quantifiable unit of access to video content, applications and algorithms (including games), artificial intelligence resources, database resources, crowd sourced labor networks, social networks, or other resource available exclusively via the virtual online environment.

In related aspects, the method may include serving the digital objects as virtual objects that are useful only in the virtual online environment that is controlled via the one or more computers. In some embodiments, the method may include configuring the electronic certificates to function as the digital currency units outside and independently of the virtual online environment. For example, the method may include operating the virtual online environment as a massively multiplayer online game or social networking environment enabling user-controlled avatars to act within a modeled three-dimensional space.

In other aspects, the method may include providing, by the at least one computer, ones of the digital certificates in exchange for at least one of a good or service excluding the digital object, or a payment in other currency. For example, the issuer may sell digital certificates for other currency, or may pay them to suppliers or service providers.

In related aspects, an apparatus for managing certificates used as a medium of economic exchange may include a processor coupled to a memory and a wireless transmitter, the memory holding instructions that when executed by the processor cause the apparatus to perform any of the methods and aspects of the methods summarized above or described in more detail below. Certain aspects of such apparatus (e.g., hardware aspects) may be exemplified by equipment such as a network interface for electronic communications. Similarly, an article of manufacture may be provided, including a non-transitory computer-readable storage medium holding encoded instructions, which when executed by a processor, may cause a specialty device configured as a certificate management apparatus to perform ones of the methods and aspects of the methods as summarized above. Further aspects and details of the methods, systems and apparatus are described below.

### BRIEF DESCRIPTION OF THE DRAWINGS

The present technology, in accordance with one or more various embodiments, is described in detail with reference to the following figures. The drawings are provided for purposes of illustration only and merely depict typical or example embodiments of the technology. These drawings are provided to facilitate the reader's understanding of the technology and shall not be considered limiting of the breadth, scope, or applicability of the technology.

FIG. 1A is a block diagram showing an example of a centralized system for managing certificates used as a medium of economic exchange.

FIG. 1B is a block diagram showing an example of a P2P system for managing certificates used as a medium of economic exchange.

FIG. 2 is a flow chart showing an example of a method for managing certificates used as a medium of economic exchange.

FIG. 3 is a flow chart showing additional aspects of the method of FIG. 2, as illustrative examples.

FIG. 4 is a schematic diagram showing aspects of an apparatus for managing certificates used as a medium of economic exchange.

### DETAILED DESCRIPTION

The present disclosure is directed to managing certificates used as a medium of economic exchange, including but not limited to methods, apparatus and systems fixing a certificate of exchange to a to a right to use or access controlled information or to access on-line resources in a specified amount (e.g., for a specified time or data amount). The present disclosure provides a solution to currencies tied to unduly-limited assets or untied to any asset in the form of a “virtual gold-standard” (VGS).

VGS takes advantage of a new kind of intrinsic value in the form of virtual goods and services. Whereas prior to the prevalence of computers and the Internet, there was no way to create a substantial multiple amount of value from any finite amount of goods or services, there now exists a way for a single virtual good to have value to more than a single recipient.

Thus, for example, a currency issuer could only sell a single ounce of gold to a buyer one time, and then the ounce of gold was no longer available by the currency issuer to sell. This limited the amount of currency available to be issued. With a virtual ounce of gold, however, the currency issuer can sell the virtual gold to a buyer, and thereby transfer the virtual gold into the buyer's account, and then still hold the code for the virtual ounce of gold, which could be sold repeatedly.

Although in the prior example, the virtual gold may not have any value, many other kinds of virtual goods and services exist that do have intrinsic value to a buyer, even if the seller retains the ability to sell that same virtual good or service to another buyer. For example, licenses to use or access copy-protected content, or access to on-line services are examples of virtual services that can, in a sense, be repeatedly sold by the same provider, without exhausting the seller's ability to sell additional units. The VGS approach may solve or reduce problems associated with some other currency systems precisely because the virtual good or service has either an intrinsic value, a value tied to at least one alternate store of value (such as an amount of gold or a price in another currency), or both.

Thus, for example, a currency issuer may own a network of virtual worlds in which access to certain features of that network require the user to have a VIP membership. The currency issuer (in this example we will call them “Virtual Web”) may then create and distribute currency (in this example, we will call the currency “Polys”) to a population for the use in commerce. If Virtual Web employs a VGS currency system, it assigns (for example) a fixed price for VIP membership to their network in Polys. Virtual Web may then also allows the same VIP membership to be purchased for at least one other currency or store of value, for example, dollars.

So, in this example, Virtual Web begins to sell VIP memberships to their network for $20 USD per month. Virtual Web similarly allows its VIP memberships to be purchased by the population for 100 Polys per month. Provided there is sufficient demand for the VIP membership within the population, this would then create a minimum value of Polys of roughly $0.20 each, since users could always choose to purchase their VIP membership either for $20 USD or 100 Polys (100×$0.20 USD=$20 USD). It is important to recognize that this system and method does not fix the value of Polys at $0.20 USD, since the value of Polys might be higher—depending on the size of the economy and the population and the demand for Polys. So, while the value of Polys is not fixed, it does have an established minimum value of about $0.20 USD, so long as there is a continuing demand for the VIP memberships and the Polys are transferable. If the price of Polys drops too far below $20, anyone wanting to purchase a VIP membership may do so at a discount, by purchasing 100 Polys at a discounted rate. Given enough demand for VIP memberships, demand pressure would push the market price of Polys back up towards $20.

As long as there is sufficient demand for the VIP membership (similar to sufficient demand for gold under a traditional gold-standard currency), this system and method provides certain clear benefits over existing currencies. Virtual Web could create additional Polys at any time, since there is no limit to the number of months of VIP services that would be able to be supplied by Virtual Web. Because Virtual Web could continue to redeem 100 Polys for 1 month of VIP service, the population would be unable to reduce the value of Polys to below the $0.20 floor. Therefore, the problem of maintaining a store of value that is equal to the value of the currency in circulation (inherent in the traditional gold-standard) is solved because the number of VIP membership months is not limited by any physical constraint, while at the same time, the inflation problem inherent in fiat currencies is solved, because the creation of additional currency generally does not dilute the value of the currency that is already in circulation below the floor value.

One feature of VGS is that the cost of the virtual good or service as it is priced in the at least one alternate store of value can fluctuate; however, the cost in of the virtual good or service as it is priced in the VGS currency itself may be fixed for at least some period of time, and if and when the cost as priced in the VGS currency itself is changed, that change would revalue the VGS currency.

In some embodiments, instead of fixing the cost of the virtual good or service as priced in the VGS currency to a set amount, the cost may be allowed to vary within a pre-determined trading price range. In addition, the VGS currency may be allowed to be traded on a marketplace or exchange or similar trading vehicle that permits buyers and sellers to perform price discovery and buy and sell the virtual good or service. In such embodiments, the inclusion of a pre-determined trading price range incorporates some of the features of a fiat currency while limiting the risks and problems as described above. In these embodiments, a change to the pre-determined trading price range would constitute a revaluing of the VGS currency.

The prior example of a virtual service is only a single example of virtual goods and services that may be used to create a VGS. It is contemplated and expected that future VGS currencies may allow holders of the currency to exchange the currency for one or more than one kind of virtual good or service. Other examples of such virtual goods or services may be digital downloads of music, movies or software. For further example, 100 Polys may entitle the owner to download 10 songs of their choice, or 5 movies or 2 new programs, or some combination of those or other virtual goods and services, or it may supply them with a certain amount of virtual space, virtual clothing, virtual commercial or residential real-estate, or any other manner of virtual good or service.

Virtual services exchanged for a VGS currency may include, for example, access to on-line computing resources, such as ability for the user to perform one advanced search on a search engine, or the ability to send one electronic message to another user; a VGS currency amount may be fixed as the exchange rate for use of a certain amount of cloud-computer storage, processing cycles and/or software time. Similarly, a certain amount of VGS currency might be exchangeable for a specified amount (e.g., an amount of time or computing resources) of play of one or more online games.

In all of the foregoing examples, it should be apparent that the sale of the virtual good to one user does not preclude the sale of an identical virtual good to other users, and the provision of a virtual service to one user does not preclude the provision of an identical virtual service to another user.

VGS currencies are not only useful for governments, and may also be useful to companies and other entities as well. Similarly, virtual currencies and point systems have also been proven to be valuable to a wide range of entities. All of these “stores of value” are subject to at least the same limitations as outlined above for government issued currencies, and thus, all manner of “stores of value” could benefit from the present disclosure.

Novel aspects of the disclosure may include the idea that the currency is being accepted at a fixed rate of exchange, or within a controlled trading range, for a virtual good. For example, suppose a company with a very large library of digital content create a virtual currency called the “songdollar” and set up its digital content store to accept payment in songdollars. The new songdollar currency would naturally assume a value related to market demand for downloading data from the digital content store, and a market could spring up to service exchanges between songdollars and other currencies. In the songdollars example, if one songdollar was always able to purchase one song, then the value imparted to the songdollar is one song. That means that there is inherent value, which is that regardless of how many songdollars are issued, the content library company provides one song download in exchange for one songdollar. Thus, no matter how many songdollars are in circulation, each songdollar has the equivalent value of one song download.

Continuing the example, if the company is selling one billion songs per year before it starts printing songdollars, then it has a revenue stream from the sale of those songs in currencies. If the company suddenly gives away a billion songdollars, they then will lose the revenue that they were gaining from the sale of their songs. They may also incur costs in connection with exchanging songs for songdollars that have to be paid in other currencies, and paying royalties to content creators. Thus, the company will not generally give away songdollars for nothing. It may, instead, sell them for other curriencies in a songdollar exchange, and/or exchange songdollars for goods and services that it needs to operate. In the alternative, or in addition, it can give away songdollars to users for performing activities that generate revenue for the company, such as viewing paid advertising.

Similar pressures are at work when an online virtual world exchanges membership access for a digital currency. If the online operator is selling VIP memberships for US dollars, it has a USD revenue stream. It may raise or lower the price that it charges in dollar terms, so, for example, next year, VIP memberships may be $25 USD, whereas this year they are $20. However, the Virtual Gold Standard currency is always fixed. If the operator needs quick cash, it can sell more of that currency, but it will always be at the expense of future revenue from other currencies, because when people have enough of the virtual currency, they can remit the VGS currency instead of paying cash.

These concepts may be better understood with reference to the relationship to the gold standard. For example, if $100 USD always could be exchanged for 1 oz of gold, then the US could not print unlimited currency, as the gold would actually be called by the newly minted currency. No value can be had simply by “printing.” The same is true for the virtual gold standard currency. An online operator cannot print unlimited certificates, because the more it prints, the less “other” “future” revenue comes in. Thus, although not limited in supply in the way natural resources such as gold or silver are, the information-backed certificates may derive scarcity, and thereby value, from the need of the issuer to receive exchangeable value for information services offered.

The US dollar no longer has inherent value with reference to another commodity, and derives it value solely from general public acceptance. Accordingly, this disclosure concerns in part imparting an inherent value to a currency in a way similar to gold. Gold no longer imparts value to any major currency now, and the example of the digital content provider is a good one. Content providers may adjust to monetary inflation by raising prices. If the US manufactures a few hundred “billion dollar platinum coins” for example, a song may cost $20 rather than $1 today. In such a case, the “songdollars” that they issued are still worth 1 song each, so a song is the inherent value, while the currencies that are not anchored to the songs may fluctuate in value. Similarly, an online operator may start charging $200 USD per month for VIP, but 250 Rays (an online currency unit used in the Utherverse virtual world servers) might still get the user a VIP pass.

In an aspect distinguishing the present system from a traditional gold standard, there is no physical limit to the redemptions in the present system. This is an added benefit. So, on a gold standard, the limitation on printing money is that the amount of money could not, in theory, exceed the amount of gold owned and available to be called by the outstanding currency. The rise of fractional reserve banking allowed central banks and governments a way around this limitation, for a while, but eventually led to destruction of the gold standard on which monetary systems rested. On the Virtual Gold Standard, the limitation is that current printing will impact future revenue, but there is actually no hard limit to printing such as imposed by physical gold.

For example, continuing the content library example, the digital content company might disperse billions of songdollars, and as a result, sacrifice an increasing amount of forward revenue, but it would always be able to redeem the songdollars with songs to the extent that the number of songs it can exchange for songdollars is not contractually limited. This makes the system more flexible, while still providing a check against runaway inflation. Under normal circumstances, the digital content company will not disburse songdollars without receiving something of value in exchange. If it values them too cheaply, the value it receives for digital content will likewise be cheapened.

A VGS currency may be issued in digital certificate form, similarly to BitCoin. BitCoin is an example of open source digital cash, authenticated using a peer-to-peer (P2P) system. Electronic certificates used for digital currency may also be authenticated with centralized systems; an example of such systems based on gold is e-gold. The present system may use any suitable form of electronic certification or token that is secure and capable of being authenticated. Bitcoin derives value from scarcity, because the number of certificates that can be generated is mathematically limited.

In the present system, the scarcity value derives from the currency issuer guaranteeing that it will redeem the issued currency on demand for an infinitely replicable (by the issuer) but nonetheless valuable intangible thing (good/service/right), for example a digital object or a right to access or use information. The intangible thing also has value in other currencies, so the issuer is foregoing revenue and/or incurring costs in other currencies whenever it redeems. Essentially, the issuer agrees to redeem the digital currency for the current cash value of the intangible thing less transaction costs, because (so long as the intangible thing is transferable) anyone can redeem the thing and sell it for cash in the desired currency. Even if the intangible thing is not transferable, someone holding the digital currency can exchange it with somebody who wishes to obtain the intangible thing, in exchange for cash. So either way the digital currency is imparted a cash value based on the market value of the intangible thing.

If the intangible thing is freely replicable by anyone, its market value may be too low to function as a store of value. But there are intangible things that are not freely replicable by anyone, for example, copy-protected digital content, or access to virtual objects, or the right to receive virtual services, in a virtual environment under the direct or indirect control of the currency issuer.

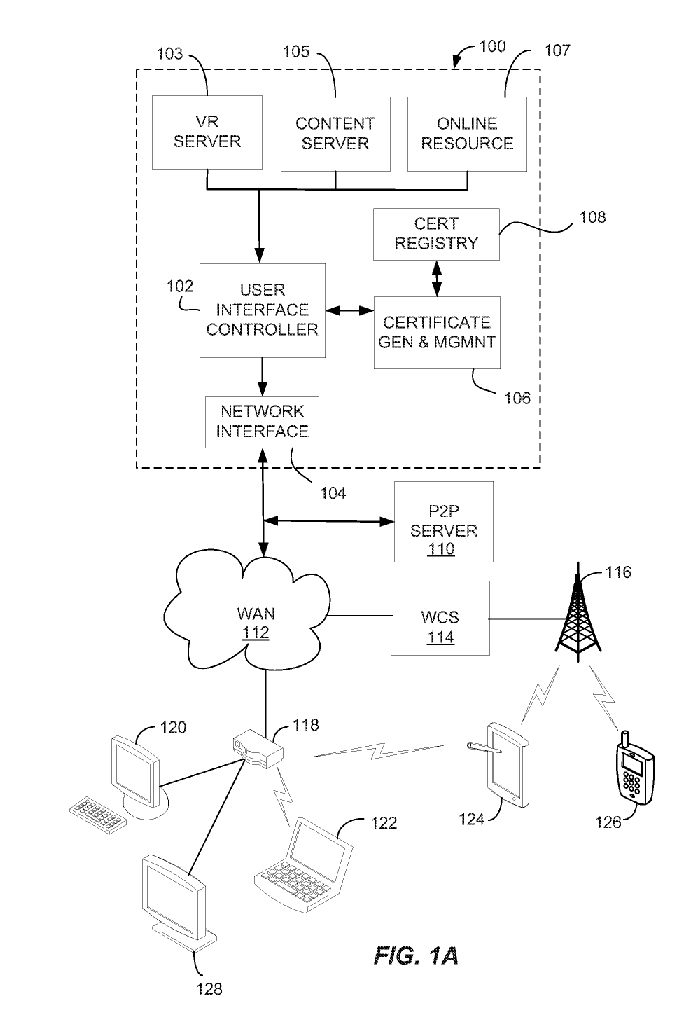

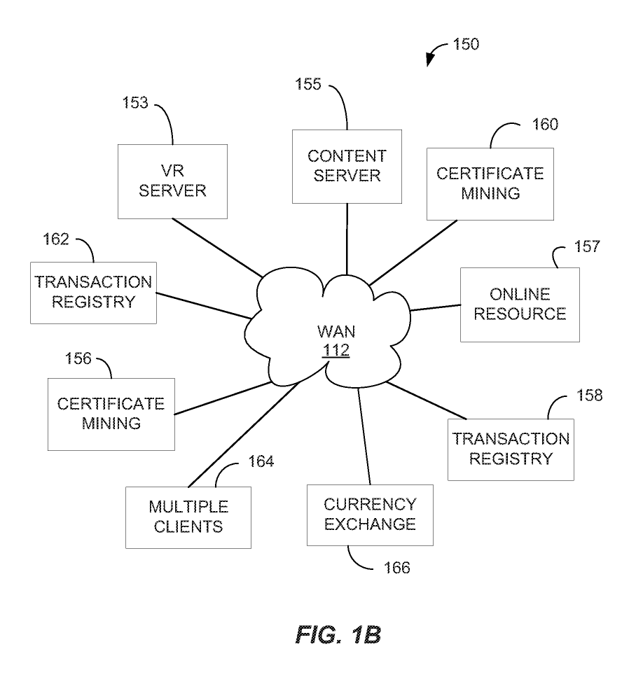

Features and aspects as disclosed herein may be implemented within a system 100 for managing certificates as a medium of exchange, in communication with multiple client devices via one or more communication networks, as shown in FIG. 1A. The system 100 may include one or more computer servers or modules 102, 103, 104, 105, 106, 107, and/or 108 distributed over one or more computers. Each server 102, 103, 104, 105, 106, 107, and/or 108 may include, or may be operatively coupled to, one or more data stores, for example databases, indexes, files, or other data structures, which may hold program data and/or instructions.

In general, the system 100 may manage issuance and redemption of electronic certificates for rights to access or use information, such rights sometimes referred to herein as “digital objects.” To these and other ends, the system 100 may include a network interface component 104 handling bidirectional data flow between client devices and the system 100 via the wide area network 112. A user interface controller 102 may handle and route data between network clients and system 100 components, and may include a component for serving a graphical user interface (GUI). The user interface controller 102 may integrate data from various inputs into a unified GUI implemented as a dynamic web page or the like, for example an HTML or XML page, including extended functionalities such as JavaScript™ modules, and manage the serving of pages to different clients.

The GUI may include a system of screens and menus enabling a user to receive electronic certificates in a first exchange, and to redeem the certificates in a second exchange for access (either online or by download) to information in a server or data store belonging to the system 100. In some embodiments, the GUI may include a three-dimensional, virtual reality interface enabling a user to access resources of the system 100 via a virtual reality world space. In an aspect, access, or a privileged level of access, to the virtual reality features of the server may be, or may be a part of, resources used to redeem electronic certificates and impart value to the certificates. Virtual reality features may include massively multiplayer online (MMO) games of various types.

The network interface 104 may receive requests for certificates or to redeem certificates from any one or more of the client devices 120, 128, 122, 124, or 126, and provide the requests to a certificate generation and management component 106. The component 106 may generate, and/or retrieve from a memory, certificates to be provided to a client, and register outgoing transactions using a registry component 108, which may function as a data store and index. For redemptions of certificates, the component 106 may authenticate a submitted certificate and register a redemption transaction, then provide a signal to the interface controller 102 or other system 100 component indicating that a requested information access should be granted to complete a redemption transaction.

One or more content servers, for example a virtual reality server 103 or digital content server 105, or online resource servers, for example online resource server 107, may service redemption transaction by granting specified rights to the user that proffers each certificate for redemption. For example, the content server 105 may provide access to a library of digital content (e.g., movies, games, videos, etc.), including online or download access, for each redemption. A virtual reality server 103 may grant a certain length of time for premium or enhanced access to a virtual reality world or game, for each redeemed certificate. An online resource server 107 may grant a certain amount of time of access to an online computing resource, for example, to a computational engine (e.g., general purpose or specialized), to bandwidth, memory, or other resources.

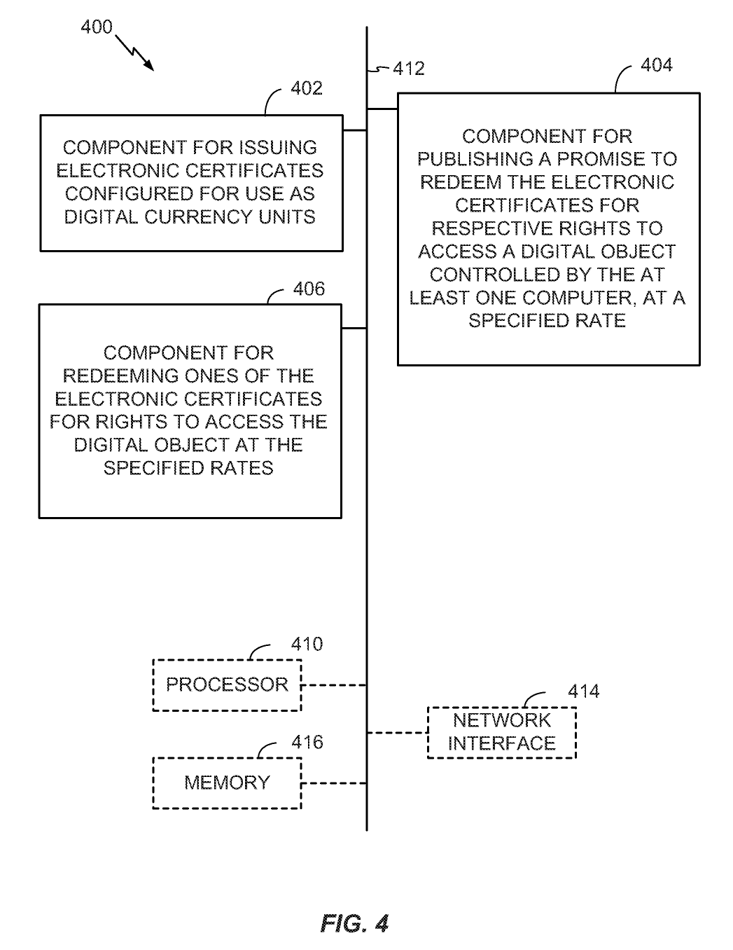

The system 100 may include other modules or units not depicted in FIG. 1A, for example diagnostic servers, commerce servers, network infrastructure, advertising selection engines, and so forth. A different description of an example of a system is provided below, in connection with FIG. 4. The present technology is not limited to the examples described herein, and one of ordinary skill may design alternative systems for providing the innovative management method and features described herein.

The system 100 may connect to a data communication network 112. A data communication network 112 may comprise a local area network (LAN), a wide area network (WAN), for example, the Internet, a telephone network, a wireless cellular telecommunications network 114, or some combination of these or similar networks. Optionally, aspects of managing or using the electronic certificates may be handled by a P2P network, for example, P2P server 110 may operate an independent exchange that accepts the certificates, or a transaction server to register certificate exchanges.

One or more client devices may be in communication with the system 100, via the data communication network 116 and/or other network 114. Such client devices may include, for example, one or more laptop computers 122, desktop computers 120, “smart” mobile phones 126, notepad devices 124, network-enabled televisions 128, or combinations thereof. Each of the client devices may be communicatively coupled to the system 100 via a router 118 for a LAN, via a base station 116 for a wireless telephony network 114, or via some other connection. In operation, such client devices 120, 122, 124, 126, 128 may send and receive data or instructions to the system 100, including requests for exchange transactions involving the digital certificate for an intangible access right, in response to user input received from user input devices or other input. In response, the system 100 may serve selected content in a GUI to the client devices 120, 122, 124, 126, 128. The devices 120, 122, 124, 126, 128 may output video, virtual reality game, multi-user game and other content from the GUI using a display screen, projector, or other video output device. In certain embodiments, the system 100 configured in accordance with the features and aspects disclosed herein may be configured to operate within or support a cloud computing environment. For example, a portion of, or all of, the servers 102, 104 or 110 may reside in a cloud server.

In general terms, each of the client devices 120, 122, 124, 126, 128 and one or more modules of the system 100 shown in FIG. 1A may be configured as or include features common to computing device, whether client or server. For example, each computing device may include a processor operatively coupled to a computer memory, which holds binary-coded functional modules for execution by the processor. Such functional modules may include an operating system for handling system functions such as input/output and memory access, a browser (e.g., Windows™ Explorer™, Mozilla™ Firefox™, Google™ Chrome™ or the like) for accessing information via the World Wide Web or similar network infrastructure, and a media player for playing streaming video and communicating with a streaming video system (e.g., Adobe™ FLASH™ of Shockwave™ player, HTML5 video player, or other audio/video playing application).

FIG. 1B shows a P2P system 150, for performing certificate issuance and redemption functions like system 100. The system may include various servers in communication via a wide area network 112, without any centralized control. Each server includes its own network interface (not shown).

One or more P2P redemption servers 153, 155, 157 may interact directly with ones of the multiple clients 164 to execute redemption transactions, providing access to information or online resources in exchange for electronic certificates. For example, a virtual reality server 153 may redeem certificates for access to an online virtual reality game; a content server 155 may redeem certificates for access to electronic content, and/or an online resource server 157 may redeem certificates for access and use of a computing resource. Each of the servers 153, 155, 157 may include an appropriate user interface component (not shown) for providing a GUI or other interface for handling redemption transaction.

One or more P2P certificate servers 156, 160 may handle generation of electronic certificates. For example, cryptographic certificates as used by Bitcoin and other P2P coins may be generated using a “mining” algorithm. Other forms of certificates may also be suitable. In some embodiments, certificate generation may be handled in a centralized fashion by a certificate issuer, with or without an algorithmically imposed limit on the number of certificates that may be generated, while other aspects of the system may be handled in a de-centralized, P2P manner.

One or more P2P registry servers 158, 162 may process transactions reported by other participants in the system 100, using a P2P registry system, for example, a block chain as introduced with Bitcoin, or any other form of collaborative registry designed to prevent double spending of electronic certificates. In general, the methods described herein for centralized systems such as system 100 may be adapted for use with P2P systems, such as system 100.

In view of exemplary systems shown and described herein, methodologies that may be implemented in accordance with the disclosed subject matter may be better appreciated with reference to various flow charts. For purposes of simplicity of explanation, methodologies are shown and described as a series of acts in blocks, but the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on non-transitory computer-readable medium to facilitate transporting and transferring such methodologies to various devices.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

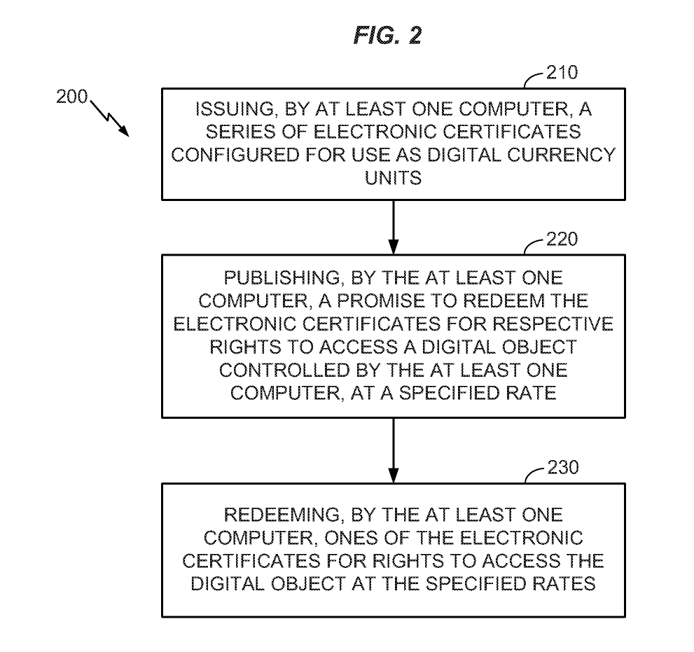

FIG. 2 is a flow chart showing an example of a method 200 managing certificates used as a medium of economic exchange in which issuance of the certificate is tied to a right to use or access controlled (e.g., copyrighted or secret) information or to access on-line resources (e.g., an on-line game, database, or processor) in a specified amount. Managing certificates may include, for example, managing exchange value by publishing and executing a promise to redeem the certificates for a specified intangible product or service supplied via an on-line environment.

In an aspect, the method 200 for managing certificates used as a medium of economic exchange may include, at 210, issuing, by at least one computer, electronic certificates configured for use as digital currency units. For example, the at least one computer may issue a series of electronic certificates for use as digital currency by providing a unique electronic identifier (for example, a cryptographic identifier, similar to certificates generated by the Bitcoin protocol) for each certificate and a publicly available register of transactions recording most recent owners of the electronic certificates. In addition, the at least one computer may associate different public/private key pairs with respective ones of the electronic certificates enabling any person knowing the private key of the pair to control transfer of the electronic certificate to a new owner. The certificates may be unitary and indivisible, or in the alternative, divisible to a specified level of granularity. The at least one computer may be controlled by a single entity, sometimes referred to herein as an “issuer.”

The method 200 may further include, at 220, publishing, by the at least one computer, a promise to redeem the electronic certificates for respective rights to access a digital object controlled by the at least one computer, at a specified rate. For example, the at least one computer may publish and maintain a redemption table showing one or more units of information or online services access for each unit (or number of units) of the electronic certificates. The specified rate may be a fixed rate, or a variable rate varying within a specified, relatively narrow range; for example plus or minus 10%. The method 200 may further include, at 230, redeeming, by the at least one computer, ones of the electronic certificates for rights to access the digital object at the specified rates, using an electronic interface, for example, a web page. In an aspect, the digital objects may comprise copy-protected digital content, access to an on-line game or social media platform, or access to an on-line computing resource. For example, the digital objects may be selected from electronic audio files or streamed audio content, audio/video files or streamed audio/video content, executable software, computer games, electronic data or computer graphic files.

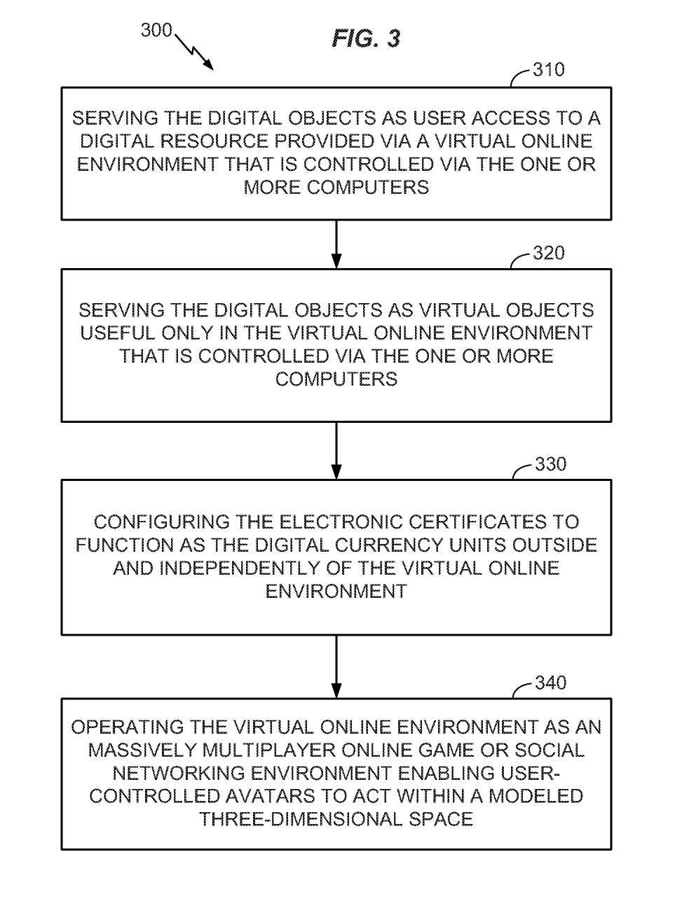

The method 200 may include any of the more detailed aspects described in connection with FIG. 3, or additional aspects described herein. FIG. 3 illustrates additional aspects and operations 300 that may be practiced in conjunction with method 200. The operations shown in FIG. 3 may not be required to perform the method 200. Operations 300 may be independently performed and not mutually exclusive. Therefore any one of such operations may be performed regardless of whether another downstream or upstream operation is performed. If the method 200 includes at least one of the operations 300, then the method 200 may terminate after the at least one operation, without necessarily having to include any subsequent downstream operation(s) that may be illustrated.

The method 200 may further include, at 310, serving the digital objects as user access to a digital resource or service provided via a virtual online environment that is controlled via the one or more computers. A digital resource or service may include, for example, a quantifiable unit of access to video content, applications and algorithms (including games), artificial intelligence resources, database resources, crowd sourced labor networks, social networks, or other resource available exclusively via the virtual online environment.

In related aspects, the method 200 may include, at 320, serving the digital objects as virtual objects that are useful only in the virtual online environment that is controlled via the one or more computers. In some embodiments, the method 200 may include, at 330, configuring the electronic certificates to function as the digital currency units outside and independently of the virtual online environment, for example by providing an independent registry or system of P2P registries. In other embodiments, the method may include, at 340, operating the virtual online environment as a massively multiplayer online game or social networking environment enabling user-controlled avatars to act within a modeled three-dimensional space.

In other aspects, the method may include providing, by the at least one computer, ones of the digital certificates in exchange for at least one of a good or service excluding the digital object, or a payment in other currency. For example, the issuer may sell digital certificates for other currency, or may pay them to suppliers or service providers. In some embodiments, the method may include distributing certificates to users in exchange for revenue-generating behavior by users, for example, viewing per-view paid advertising or purchasing sponsors' products.

Consistent with method 200, and as further illustrated by FIG. 4, an apparatus 400 for managing certificates used as a medium of exchange via a redemption for intangible good or services may perform method 200 and any of the more detailed algorithms described herein. The apparatus 400 may comprise an electronic component or module 402 for issuing electronic certificates configured for use as digital currency units. Said module 402 may be, or may include, a means for issuing electronic certificates configured for use as digital currency units. Said means may comprise a processor executing an algorithm, the algorithm including, for example, issuing a series of unique, authenticable certificate numbers, and recording at least a first transaction including an account identifier of a person accepting each respective certificate, based on respective ones of the certificate numbers, in a registry. The registry may be centralized or peer-to-peer.

The apparatus 400 may comprise an electronic component or module 404 for publishing a promise to redeem the electronic certificates for respective rights to access a digital object controlled by the at least one computer, at a specified rate. Said module 404 may be, or may include, a means for publishing a promise to redeem the electronic certificates for respective rights to access a digital object controlled by the at least one computer, at a specified rate. Said means may comprise a processor executing an algorithm, the algorithm including, for example, determining the specified rate (either fixed and static, or variable within a range), including, for example recovering the rate from a memory or computing a variable rate based on at least one parameter. The algorithm may further include updating a web page with the determined rate.

In addition, the apparatus 400 may comprise an electronic component or module 406 for redeeming ones of the electronic certificates for rights to access the digital object at the specified rates. Said module 406 may be, or may include, a means for redeeming ones of the electronic certificates for rights to access the digital object at the specified rates. Said means may comprise a processor executing an algorithm, the algorithm including, for example, receiving a transaction request including an offer to exchange a digital certificate for an intangible digital object; authenticating the certificate; receiving ownership of the certificate by providing a recipient identifier, and providing access to the digital object according to the request.

The apparatus 400 may optionally include a processor module 410 having at least one processor; in the case of the apparatus 400 this may be configured as a content server and certificate management processor, rather than as a general purpose microprocessor. The processor 410, in such case, may be in operative communication with the modules 402-406 via a bus 412 or similar communication coupling. The processor 410 may effect initiation and scheduling of the processes or functions performed by electrical components 402-406, and other operations described in connection with the method 200 or any of the detailed algorithms described herein above.

In related aspects, the apparatus 400 may include a network interface module 414 through with the processor 410 may send and receive information to clients and other servers. In further related aspects, the apparatus 400 may optionally include a module for storing information, such as, for example, a memory device/module 418. The computer readable medium or the memory module 418 may be operatively coupled to the other components of the apparatus 400 via the bus 412 or the like. The memory module 418 may be adapted to store computer readable instructions and data for effecting the processes and behavior of the modules 402-406, and subcomponents thereof, or the processor 410, or the methods disclosed herein. The memory module 418 may retain instructions for executing functions associated with the modules 402-406. While shown as being external to the memory 418, it is to be understood that the modules 402-406 may exist at least partly within the memory 418.

Various aspects are presented herein in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. A non-transitory computer readable medium may include but is not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of computer-readable storage medium known in the art. A non-transitory computer-readable storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. The foregoing embodiments merely exemplify various apparatus and systems for managing certificates used as a medium of economic exchange. The present technology is not limited by these examples.

What is claimed is:

1. A virtual environment hosted on one or more computers configured as virtual environment servers, the virtual environment comprising:
restrictions for users who have not paid a membership fee;
a first membership fee denominated in a virtual gold standard (VGS) currency, wherein a fixed number of units, N, is the long-term fixed price of membership;
a second membership fee comprising a fee denominated in a government-issued non-virtual currency (government currency), wherein the number of units of government currency required for membership may vary as the exchange rate between the government currency and other goods, services or currencies vary, without changing the long-term fixed price of membership denominated in VGS currency;
a marketplace or other means of exchange between the VGS currency and the government currency; and
wherein the restrictions are removed for the users after payment of the membership fee in either VGS currency or government currency.

2. The virtual environment of claim 1, wherein the long-term fixed price is a pre-determined trading price range for the VGS currency for which membership may be exchanged in the marketplace.

3. The virtual environment of claim 1, wherein a change in the long-term fixed price range for the VGS currency constitutes revaluing the VGS currency.

4. The virtual environment of claim 1, further comprising a series of electronic certificates issued as the VGS currency, each electronic certificate having a unique electronic identifier and a publicly available register of transactions recording exchanges between the series of electronic certificates and the government currency.

5. The virtual environment of claim 4, wherein different public/private key pairs are associated with respective ones of the electronic certificates enabling a person knowing a private key of a key pair to control transfer of a respective one of the electronic certificates.

6. The virtual environment of claim 1, wherein the restrictions limit access to certain features of the virtual environment.

7. The virtual environment of claim 1, wherein the one or more computers may create additional VGS currency at any time.

8. A system for managing electronic certificates used as a medium of exchange comprising:
a first device holding the electronic certificates for use as virtual gold standard (VGS) currency, wherein a fixed number of units, N, of the VGS currency is a long-term fixed price of membership in a virtual environment;
a second device for redeeming ones of the electronic certificates;
a wireless transmission device for transmitting the electronic certificates from the first device to the second device;
wherein the second device redeems ones of the electronic certificates for memberships in the virtual environment based on N.

9. The system of claim 8, wherein the virtual environment is a massively multiplayer online game enabling user controlled avatars to act within a modeled three-dimensional space.

10. The system of claim 8, wherein the VGS currency is usable only within the virtual environment.

11. The system of claim 8, wherein the electronic certificates are configured as VGS currency for use outside and independently of the virtual environment.

12. The system of claim 8, wherein a price of membership in the virtual environment is also denominated in a government issued non-virtual currency (government currency) that may vary as the exchange rate between the government currency and other goods, services or currencies vary, but where the fixed number of units, N, which constitutes the long-term fixed price of membership does not change.

13. The system of claim 12, wherein the VGS currency and the government currency may be exchanged in a marketplace.

14. The system of claim 13, wherein the electronic certificates have a unique electronic identifier for each electronic certificate and a publicly available register records most recent owners of the electronic certificates.

15. The system of claim 14, wherein different public/private key pairs are associated with respective ones of the electronic certificates thereby enabling a person knowing a private key of a pair to control transfer of a respective one of the electronic certificates to a new owner.

16. A method for managing a series of electronic certificates used as a medium of exchange comprising:
issuing, by a first device, the series of electronic certificates configured for use as virtual gold standard (VGS) currency, wherein a fixed number of units, N, of electronic certificates is a long-term fixed price of membership in a virtual environment;
publishing, by the first device, the fixed number of units, N, as the long-term fixed price of membership in the virtual environment;
transmitting, via a wireless transmission device from the first device to a second device the series of electronic certificates;
wherein the second electronic device redeems the series of electronic certificates for memberships in a virtual environment based on the long-term fixed price.

17. The method of claim 16, wherein a price of membership in the virtual environment is also denominated in a government issued non-virtual currency (government currency) that may vary as the exchange rate between the government currency and other goods, services or currencies vary, but where the fixed number of units, N, which constitutes the long-term fixed price of membership does not change.

18. The method of claim 17, wherein the VGS currency and the government currency may be exchanged in a marketplace.

19. The method of claim 18, further comprising providing a unique electronic identifier for each electronic certificate and a publicly available register of transactions recording most recent owners of the electronic certificates.

20. The method of claim 19, further comprising associating different public/private key pairs with respective ones of the electronic certificates thereby enabling a person knowing a private key of a pair to control transfer of a respective one of the electronic certificates to a new owner.
